(19) United States
(12) Patent Application Publication
(10) Pub. No.: US 2005/0131921 A1
(43) Pub. Date: Jun. 16, 2005

(54) Extended naming service framework

(76) Inventors: Kaustabh Debbarman, Tampere (FI); Kari Silfverberg, Mouhijarvi (FI); Juha Havulinna, Tampere (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/966,159

(22) Filed: Oct. 18, 2004

Related U.S. Application Data
(63) Continuation of application No. PCT/FI03/00235, filed on Mar. 27, 2003.

(30) Foreign Application Priority Data
Apr. 19, 2002 (FI) 20020765

(51) Int. Cl. G06F 7/00

(52) U.S. Cl. 707/100

(57) ABSTRACT

The present invention describes a dynamic managing method, system and extended naming service framework for enabling service availability in a computer system comprising at least one or more client applications, one or more server applications for providing one or more services, and wherein the client applications use one or more services. The system further comprises one or more entities or pieces of physical equipment for providing one or more server applications and a management entity for supervising and recovering the entities or physical equipment. The framework provides a solution to the problem of locating and managing services within a system. The framework provides a centralised storage of information about all the services within a system, although it can also be a distributed solution as well. Source of information about the services are the service providers themselves or mapped information from HA notifications concerning physical equipment, e.g. a LAN port etc.

This is a Continuation of International Application No. PCT/FI03/00235 filed Mar. 27, 2003, which designated the U.S. and was published under PCT Article 21(2) in English.

### FIELD OF THE INVENTION

The present invention relates to mobile telecommunication systems. In particular, the present invention relates to a novel and improved method, system and extended naming service framework for guaranteeing service availability.

### BACKGROUND OF THE INVENTION

Data communication and computer networks provide different kinds of services to parties requesting services. Service here refers to any instance, for example software or hardware components that are capable of offering some kind of useful information for other entities, users or clients.

An important property for a service is that it is available as much as possible. Some services are more important than others, and therefore the down time or fault time of the most important services should be minimised. Also an important aspect is that the state information (e.g. failure, down, etc.) should be available to the instances that might need the information, e.g. other service users that might send a service request to the service. In some occasions, a process provides only one service. However, there may be situations where a single process is offering one or more services.

It can be said that most of the computer and data communication systems have some kind of management system. The task of the management system is to monitor the functions of the system, report failures and manage possible recovery processes. The object to be monitored can be, e.g. a hardware component, e.g. a Computer Processing Unit (CPU) or a software component, service or process. Mobile networks comprise different kinds of Network Management Systems (NMS).

Conventional problem handling systems are often rule based solutions. This means that there are beforehand generated rules, and when a failure occurs, some information is acquired about the failure, and based on the rules affects of the failure are concluded. What is even more problematic is that the rules are often customer-specific. The main problem with the predetermined rules is that someone has generated the rules, and they are more or less based on before experienced situations. The weakness of the rule based solutions is that they are static by nature.

When a failure occurs, according to rule based solution, the predetermined rules are gone through, and it is tried to be decided what effects the failure causes. Imagine a situation where a certain failure has not occured ever, so there will not be any proper rule to apply. Therefore, we have a failure situation, and we do not any specific information what are the affects of the failure.

There exists high-availability carrier-grade server platforms. The use of mainstream hardware technologies and open-interface software components facilitate fast product creation. These network servers will eventually supersede, e.g. current mobile switches, enabling mobile networks to provide rich-call capabilities far beyond present voice and messaging-centric services.

Currently some systems use so called High Availability Services (HAS). The HAS provides services to build a system that is highly available i.e. provides good service. Clients are interested of service access points called Integration Reference Points (IRP). A client refers to an entity, e.g. a software process, which is able to use different services. A process can include many services, and thus many service access points.

A problem arises when the High Availability Services (HAS) finds that e.g. some process or physical equipment, e.g. a disk is broken. The problem is to determine which services are affected. Prior art solutions do not provide unambiguous answers to this important question. In current circuit switched based world the architecture was based on processes and communication between them. There the client knew their counterpart processes, and thus affect of some process failure was predictable, and it was possible to recover from the situation just with the HAS concept.

However, in the present architecture model the main points are services and their access points. The clients are not interested in the physical items like processes providing the services. Clients are only interested in the service access points (IRP) and their run-time references. This gives freedom to pack services in many ways, and thus provides very flexible architecture to support different kind of physical entities of the services.

### SUMMARY OF THE INVENTION

The present invention describes a dynamic managing method, system and extended naming service framework for enabling service availability in a computer system. The computer system comprises at least one or more client applications, one or more server applications for providing one or more services, wherein the client applications use one or more services. The system further comprises one or more entities or physical components for providing one or more server applications and a management entity comprising information about the entities or pieces of physical equipment.

The extended naming service framework described in the present invention provides a solution to the problem of locating and managing services within a system. The framework provides in a preferred embodiment a centralised storage of information about all the services within a system. However, the extended naming service framework can also be a distributed solution as well. Source of information about the services are the service providers themselves or mapped information from the HA notifications concerning physical components, e.g. a LAN port etc.

Service availability must be transparent to service users. Service providers, even if they aid in service availability must not implement service availability themselves. The present invention provides a generic solution for implementing service availability.

The High Availability Services receive information e.g. of failures of physical component (Central Processing Units (CPU), Local Area Networks (LAN)), processes etc. Service users (client applications) are not interested in processes but in the service access points. Service providers can provide the “physical” details (e.g. process info) of their services to the extended naming service framework. By listening to the HAS notifications regarding physical components, the extended naming service framework can map the status of a service to the status of the physical component which provides the actual service.

The present invention has several advantages over the prior art solutions. The present invention provides a generic and dynamic solution for service availability. With the present invention it is possible to map processes or physical equipment to services provided by them.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a block diagram illustrating of the functioning entities in accordance with the present invention,

FIG. 2 illustrates an example of service registration and service subscription,

FIG. 3 illustrates an example of a graceful shutdown procedure of a service provider,

FIG. 4 illustrates an example of service provider switchover, and

FIG. 5 illustrates an example of retrieving a service interface address from the extended naming service framework.

### DETAILED DESCRIPTION OF THE INVENTION

Reference will now be made in detail to the embodiments of the present invention, examples of which are illustrated in the accompanying drawings.

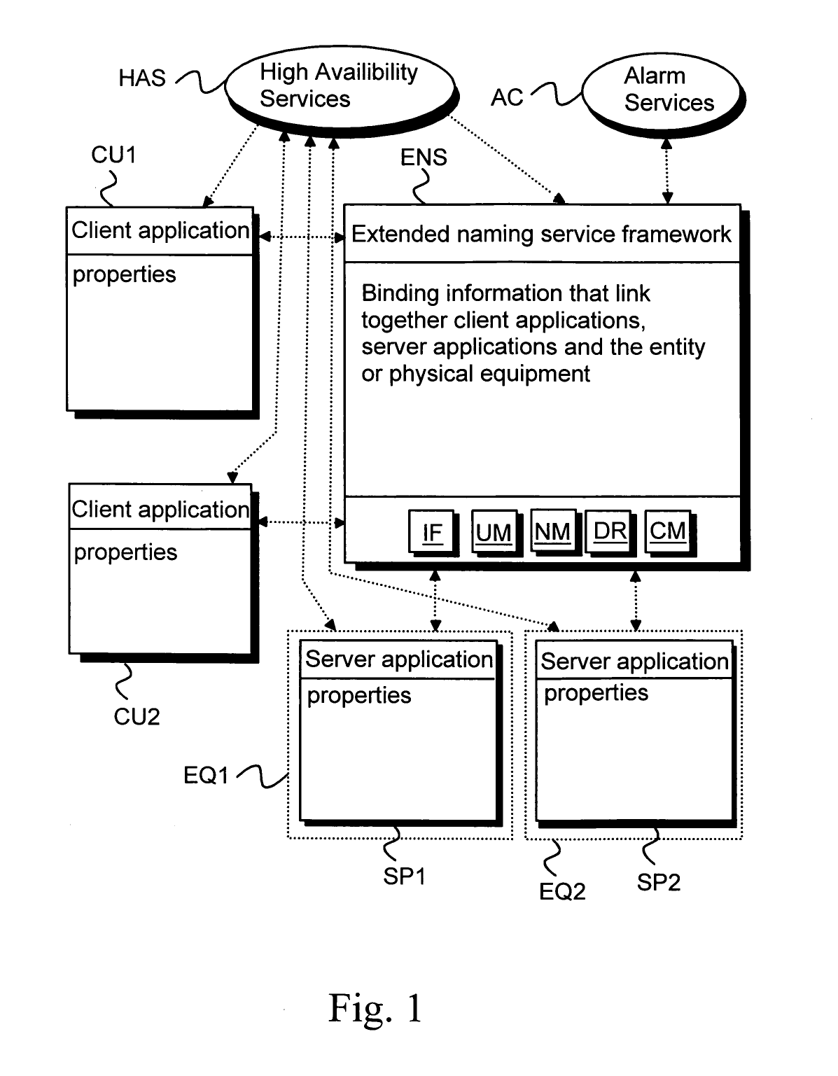

FIG. 1 describes an embodiment of a system in accordance with the present invention. The system comprises two client applications (CU1, CU2) and two service providers (SP1, SP2). A client application is a service user which uses services provided by server applications. A server application is a service provider providing one or more services.

High Availability Services HAS receive information e.g. of failures of physical components, e.g. Central Processing Units (CPU), Local Area Networks (LAN), processes etc. The HAS manages the Recovery Units (RU), which include the processes. The recovery unit is usually responsible for a service but in practice it can include multiple service access interfaces or Integrated Reference Points (IRP).

Broken lines represent possible messaging routes. The main idea of the present invention is that the extended naming service framework ENS stores detailed information concerning client applications (CU1, CU2) and server applications (SP1, SP2). When a failure situation occurs the extended naming service framework ENS comprise all the needed information to conclude which services will suffer due to the failure.

The system in accordance with the present invention may also comprise Alarm Services AS (as in FIG. 1) which reports alarm situations. The present invention provides a powerful tool to be used with alarm reporting. Typically an AS reduce the number of alarm reports (or events) sent further, e.g. to Network Management System (NMS). In many cases, problems with physical entities are found out but it is not possible to know which services are effected, if any. Therefore it would ease the NMS operator corrective actions if it would get a better alarm report when alarm is raised based on the hardware supervision. The present invention enables that each alarm based on hardware supervision can be linked to the corresponding service by using extended naming service framework ENS. In a situation of this kind, the AS, when receiving an (hardware related) alarm, asks corresponding impact to services from the ENS, and controls alarm report based on that. Previously this problem has been solved by using alarm correlation rules, but they are static by nature and are based on system study and prediction, and not in real operative bindings as the present invention describes.

The HAS will start the processes, and in the startup of a process the HAS will give the process physical location information and state of the process (active or standby) . So when the process is started, the current physical location will be told to it (like cluster-node-Recovery Unit) as well as the process state. After the process is started by the HAS, the process will register all service access points to the ENS. In these registration messages (or one big registration message) to the ENS, the process will add also the physical location of the service access point or integration reference point (IRP) and the state. Process can also give some other keys that could be used to subscribe the service later by the clients. After registering the ENS will have information like “IRP, IRP state (=process state), physical location, other search keys”.

Now, if something goes wrong with some CPU node or with some process, the HAS will send this information to the ENS. The ENS is now able to bind this information concerning the physical component to the real service access points. The ENS is able to change the statuses of the IRPs according to the physical component states.

The system represented in FIG. 1 solves the problem of managing Service Availability. Service Availability must be transparent to service users. Service Availability is a common requirement for many services. The usage of the ENS is also flexible. Service users and providers can decide to use all the features provided by the framework, or only a limited set of features. For example, depending on the configuration, the framework can act as a simple the Common Object Request Broker Architecture (CORBA) naming service for some providers and users.

In FIG. 1, server application SP1 is provided by entity or physical equipment EQ1 and server application SP2 by entity or physical equipment EQ2. The entity or physical equipment (EQ1, EQ2) refer e.g. to servers or processes.

In one embodiment of FIG. 1, the extended naming service framework ENS comprises one or more of the following means:
an interface IF for receiving from the management entity HAS a notification that an entity or a piece of physical equipment EQ is malfunctioning
means for updating UM status information of services SE which are provided by the malfunctioning entity or piece of equipment EQ;
means for notifying NM the changed status information to client applications SU that are registered to use the services SE provided by the malfunctioning entity or piece of equipment EQ,
an interface for receiving IF a service subscription from a client application SU,
means for notifying NM a client application SU when a status of a service SE of which the client application SU is aware of, changes.
an interface for receiving IF a service search request from a client application SU;
means for providing NM the client application SU the requested service information if a service SE matches search criteria,
one or more distribution rules DR to be applied when a service SE registered in the extended naming service framework ENS comprises two or more instances of a service SE,
an interface for receiving IF a request for services SE that are linked to the failed one or more entities or physical components EQ,
means for checking CM the information of the services SE, and
means for sending NM information about those services SE linked to the failed one or more entities or physical components (EQ).

The above mentioned means are in one embodiment implemented by using hardware and/or software components.

In one embodiment of FIG. 1, the extended naming service framework ENS supports service access protocols other than the CORBA as well. The messaging path can be any protocol, and not necessarily the CORBA.

In one embodiment of FIG. 1, service users are able to search for services from the extended naming service framework ENS based on flexible service hunting policies. For example, a service user can ask for a service which is serving a particular database fragment. It must be possible for service users to find the address of an interface executing a particular instance of a service from the extended naming service framework ENS. The search criterion in such a case can be e.g. the exact instance identifier of the particular service instance in question.

In one embodiment of FIG. 1, the extended naming service framework ENS supports service pool functionality. Different instances of the same service can constitute a service pool. The ENS is able to create and manage such a service pool. The ENS is able to apply distribution policies to the different service instances within the pool. The distribution policies comprise, e.g. least loaded server, least recently used (LRU) server, round robin (RR) etc.

In one embodiment of FIG. 1, the ENS comprises service provider load management functionality. Service providers inform the ENS when they are under heavy load. This decision can be on the basis of collecting some system data or statistics. In such a case, the ENS must not update any new service users with information about the particular service instance in question. It can also inform existing service users, aware of the service instance, with the status of the service (under heavy load).

In one embodiment of FIG. 1, the ENS provides standard CORBA name service functionality to service providers and users. However, the additional name service can also be other naming service than CORBA as well. The framework provides also a CosNaming interface. The ENS can act as a delegate between the commercial CORBA naming service implementation and the application using the naming service. Service providers can advertise their services using either the CosNaming interface or the additional mechanisms provided by the extended naming service framework. However, service users must be aware of which services are to be retrieved from the CORBA naming service, and which services are to be retrieved using the additional mechanisms provided by the ENS. In this way all Name Service related functionality is concentrated in one place.

In another embodiment of FIG. 1, the system comprises standard CORBA name service and the ENS in separate places.

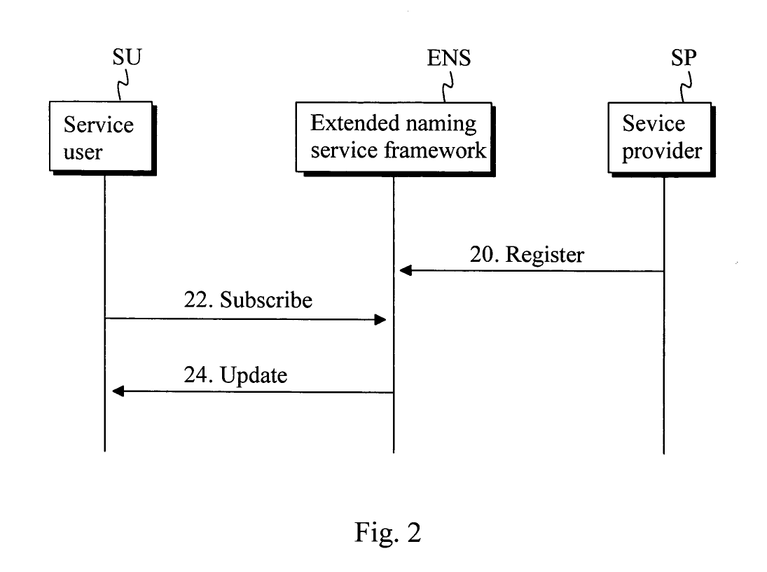

FIG. 2 represents a service registration example in accordance with the present invention. Registration may happen, e.g. during system start up, or when the service provider is started/restarted.

The service provider SP registers its services to the extended naming service framework ENS (20), e.g. using CORBA communication. In a preferred embodiment, the registration includes the following information:
Service name.
Service access point point to which the service belongs.
Interface address of the service.
Physical information about the service (node information, process information etc.).
Service status (e.g. active or standby)

After registration, the service is successfully registered to the ENS and is identified by a unique identity.

FIG. 2 represents also service subscription procedure where a service user SU subscribes to services from the extended naming service framework ENS. This may happen, e.g. during system start-up, or when the service user is started or restarted.

The service user SU subscribes to services from the framework ENS (22), using e.g. a CORBA call. In a preferred embodiment, the subscription includes the following information:
Service name.
Service access point to which the service belongs.
Required physical and other properties of the service.
Service status (e.g. active or standby).
Number of instances of the service if the user is interested to know.
The reference of the callback interface for the service user. This is the interface that the framework uses for updating the service user.

The service user SU has now successfully subscribed to services from the framework. If there are services available, which match the subscription, the service user is updated immediately (24). This update information has all the information about the service, including the service identifier, the service name, the IRP, the interface address of the service, physical information about the service as well as the service status. When a service registers, service users whose subscription matches to the registered service, are updated. In other words, a service user automatically receives service information with which it is involved with. To manage service subscription, the extended naming service framework ENS can build dynamic table concerning the relationship between clients and the services. By using this table the ENS is able to push information concerning the service status changes only to the clients that are interested of the IRPs in question.

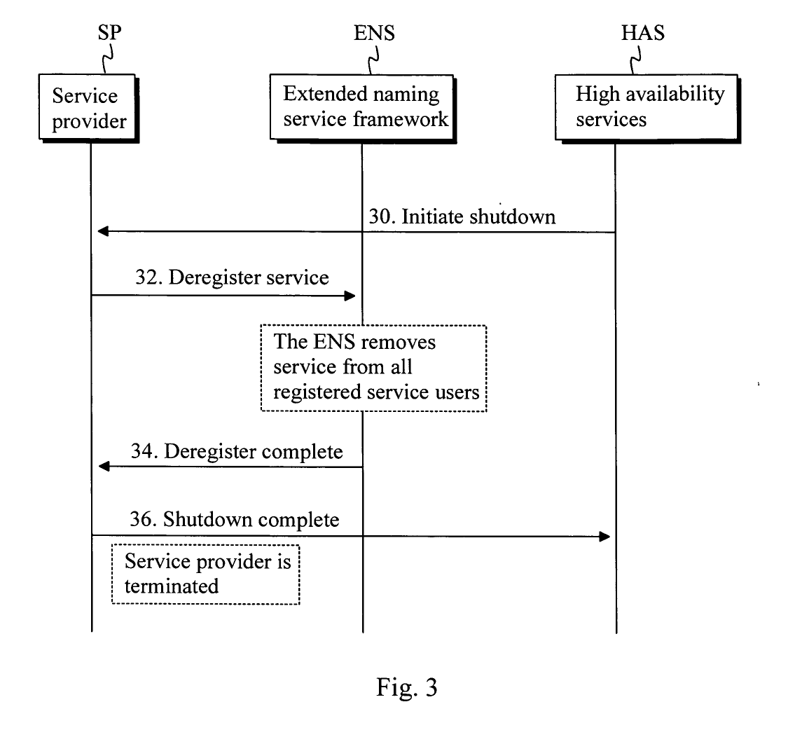

FIG. 3 represents an example of a graceful shutdown procedure. Graceful shutdown means degradation of a system in such a manner that it continues to operate, but provides a reduced level of service rather than failing completely. Graceful shutdown may happen, e.g. during system shut down or during service provider upgrade.

The extended naming service framework ENS is up and running. The HAS initiates (30) the shutdown sequence of the service provider. Initiating a shutdown sequence means that new requests are not accepted any more. The service provider indicates (deregistration message) to the framework that it is gracefully shutting down (32). The extended naming service framework ENS removes the service information from its list of available services. It also updates all the users who are aware of this particular service instance with the new status of the service. Further, the extended naming service framework ENS informs the service provider SP that all service users being aware of the service have been updated (34). Finally, the service provider SP informs the HAS that the shutdown sequence has been completed and shuts down itself (36). Because all service users which were aware of this particular service instance are updated, the service users do not initiate any new transactions with the service instance.

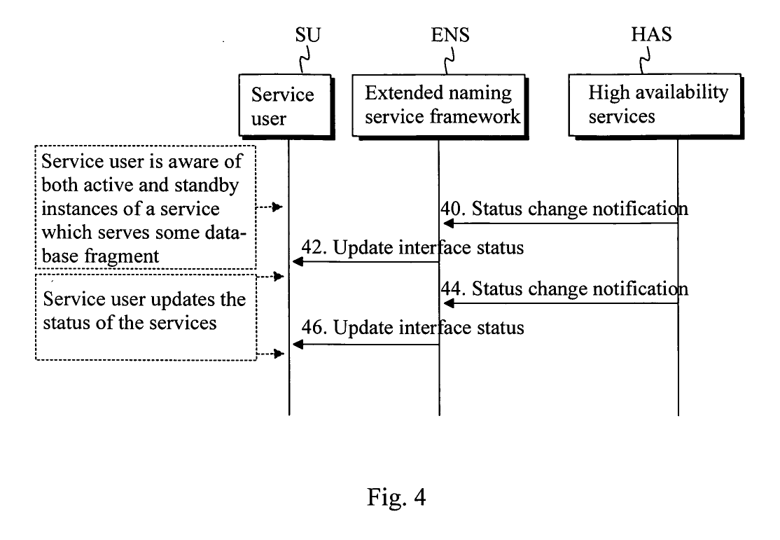

FIG. 4 represents an example of service switchover. In FIG. 4, a recovery unit on which a particular service instance is running switches over.

The initial state of FIG. 4 is that the service user is aware of both active and standby instance of a service which serves, e.g. some database fragment. The extended naming service framework ENS is up and running and is registered as a consumer for notifications regarding recovery unit switchovers from the CORBA Notification service.

The extended naming service framework is listening to HAS notifications regarding status change (active or standby etc.) of recovery units. It receives a notification that the status of a particular recovery unit has gone to standby mode (40). It maps this switchover information to the information regarding to the physical properties of the service instances as provided by the service providers themselves. In other words, the extended naming service framework ENS finds out which services were running on this particular recovery unit. As said before, the service user is assumed to be aware of both the active and standby instance of a particular service. The recovery unit which hosted the active instance of the service has switched over and gone to standby. Therefore, the extended naming service framework ENS updates the service user SU with the changed status of the service instance (active to standby) (42).

The extended naming service framework ENS now receives a notification that a particular recovery unit has switched to active state which can be mapped to the status of the services that are running on this recovery unit (44). The ENS then updates all the service users SU, which are subscribed to information about the service instances under question (46). The service users SU have now been informed of the new status of the services.

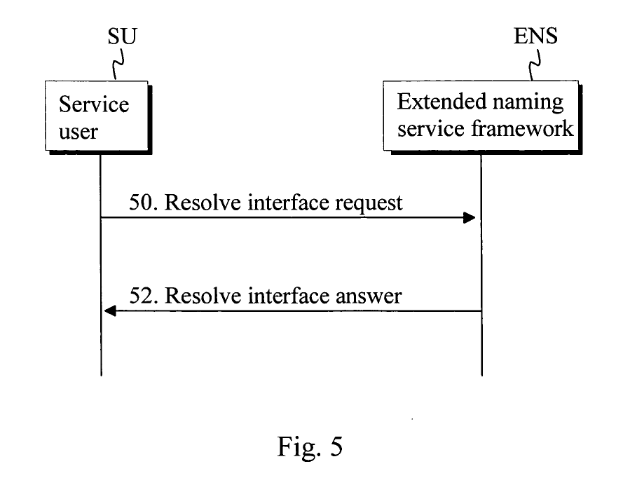

FIG. 5 represents an example of retrieving the interface address for a particular service instance. The service user SU requests the interface address of a particular service by providing the service name and the service instance identifier to the extended naming service framework ENS (50). If the requested service is already registered to the extended naming service framework ENS, the ENS returns the interface address (e.g. CORBA IOR) of the requested service to the service user SU (52). If the interface address is not available, the extended naming service framework ENS generates an exception. Request for a particular interface address occurs whenever the service user needs to invoke the particular service instance and the address of the instance is not available.

It is obvious to a person skilled in the art that with the advancement of technology, the basic idea of the invention may be implemented in various ways. The invention and its embodiments are thus not limited to the examples described above, instead they may vary within the scope of the claims.

1. A dynamic managing method for enabling service availability in a computer system, wherein said computer system comprises at least one or more client applications, one or more server applications for providing one or more services, and wherein said client applications use said one or more services, one or more entities or pieces of physical equipment for providing said one or more server applications, a management entity comprising information about said entities or pieces of physical equipment,
characterised in that the method further comprises the steps of:
registering in an extended naming service framework one or more services;
storing in said extended naming service framework information about said one or more services, said information acquired in said registering process of said services; and based on the stored information,
linking within the extended naming service framework a certain service to a certain entity or physical equipment providing said service.

2. The dynamic managing method according to claim 1, characterised in that the method further comprises the steps of:
registering in an extended naming service framework one or more client applications;
storing in said extended naming service framework information about said client applications, said information acquired in said registering process of said client applications; and based on the stored information,
linking a certain client application to a certain service.

3. The dynamic managing method according to claim 2, characterised in that said information of said client applications comprise at least one of the following:
name of the client;
interface address of the client;
client status; and
physical information about the client.

4. The dynamic managing method according to claim 1, characterised in that said information of said services comprise at least one of the following:
name of the service;
service access point to which the service belongs;
interface address of the service;
service status; and
physical information about the service.

5. The dynamic managing method according to claim 1, characterised in that the method comprises the steps of:
receiving from said management entity a notification that an entity or a piece of physical equipment is malfunctioning; and
updating status information of services which are provided by said malfunctioning entity or piece of equipment.

6. The dynamic managing method according to claim 5, characterised in that the method comprises the step of:
notifying the changed status information to client applications that are registered to use said services provided by said malfunctioning entity or piece of equipment.

7. The dynamic managing method according to claim 1, characterised in that the method comprises the steps of:
receiving a service subscription from a client application, wherein said service subscription comprises at least one or more of the following:
name of the service in question;
service access point to which said service belongs;
physical or other properties of said service;
service status;
service availability;
number of instances of said service; and
reference of the callback interface for said client application.

8. The dynamic managing method according to claim 7, characterised in that the method comprises the step of:
notifying a client application when the status of a service of which said client application is aware of, changes.

9. The dynamic managing method according to claim 1, characterised in that the method comprises the steps of:
receiving a service search request from a client application; and
providing said client application requested service information if a service matches search criteria.

10. The dynamic managing method according to claim 9, characterised in that search criteria comprises one or more of the following:
instance identifier of a service; or
a particular database fragment.

11. The dynamic managing method according to claim 1, characterised in that when a service registered in the extended naming service framework comprises two or more instances of a service,
applying one or more distribution rules to said instances.

12. The dynamic managing method according to claim 1, characterised in that the method comprises the steps of:
detecting a failure in one or more entities or pieces of physical equipment;
receiving with said extended naming service framework a request for services that are linked to said failed one or more entities or pieces of physical equipment;
checking said information of said services; and
sending information about those services matching to the request.

13. The dynamic managing method according to claim 1, characterised in that the computer system comprises at least one extended naming service framework.

14. The dynamic managing method according to claim 1, characterised in that said extended naming service framework functionality is implemented using the CORBA.

15. The dynamic managing method according to claim 1, characterised in that said extended naming service framework is a standalone naming service.

16. The dynamic managing method according to claim 1, characterised in that said extended naming service framework is part of a conventional naming service.

17. A dynamic managing system for enabling service availability in a computer system, wherein the system comprises at least:
one or more client applications (SU);
one or more server applications (SP) for providing one or more services (SE), and wherein said client applications (SU) use said one or more services (SE);
one or more entities or pieces of physical equipment (EQ) for providing said one or more server applications;
a management entity (HAS) comprising information about said entities or pieces of physical equipment;
characterised in that the system further comprises:
an extended naming service framework (ENS) for registering one or more services (SE), wherein said extended naming service framework (ENS) stores information about said one or more services (SE), said information acquired in said registering process of said services (SE), and links a certain service to a certain entity or physical equipment (EQ) providing said service (SE).

18. The dynamic managing system according to claim 17, characterised in that said extended naming service framework registers one or more client applications (SU) and stores information about said client applications (SU), said information acquired in said registering process of said client applications (SU), and links a certain client application (SU) to a certain service (SE).

19. The dynamic managing system according to claim 18, characterised in that said information of said client applications (SU) comprise at least one of the following:
name of the client;
interface address of the client;
client status; and
physical information about the client.

20. The dynamic managing system according to claim 17, characterised in that said information of said services (SE) comprise at least one of the following:
name of the service;
service access point to which the service belongs;
interface address of the service;
service status; and
physical information about the service.

21. The dynamic managing system according to claim 17, characterised in that the extended naming service framework (ENS) comprises:
an interface (IF) for receiving from said management entity (HAS) a notification that an entity or a piece of physical equipment (EQ) is malfunctioning; and
means for updating (UM) status information of services (SE) which are provided by said malfunctioning entity or piece of equipment (EQ).

22. The dynamic managing system according to claim 21, characterised in that the extended naming service framework (ENS) comprises:
means for notifying (NM) the changed status information to client applications (SU) that are registered to use said services (SE) provided by said malfunctioning entity or piece of equipment (EQ).

23. The dynamic managing system according to claim 17, characterised in that the extended naming service framework (ENS) comprises:
an interface for receiving (IF) a service subscription from a client application (SU), wherein said service subscription comprises at least one or more of the following:
name of the service (SE) in question;
service access point to which said service (SE) belongs;
physical or other properties of said service (SE), service (SE) status;
service (SE) availability;
number of instances of said service (SE); and
reference of the callback interface for said client application (SU).

24. The dynamic managing system according to claim 23, characterised in that the extended naming service framework (ENS) comprises:
means for notifying (NM) a client application (SU) when a status of a service (SE) of which said client application (SU) is aware of, changes.

25. The dynamic managing system according to claim 17, characterised in that the extended naming service framework (ENS) comprises:
an interface for receiving (IF) a service search request from a client application (SU); and
means for providing (NM) said client application (SU) the requested service information if a service (SE) matches search criteria.

26. The dynamic managing system according to claim 25, characterised in that the search criteria comprises one or more of the following:
instance identifier of a service; or
a particular database fragment.

27. The dynamic managing system according to claim 17, characterised in that the extended naming service framework (ENS) comprises one or more distribution rules (DR) to be applied when a service (SE) registered in the extended naming service framework (ENS) comprises two or more instances of a service (SE).

28. The dynamic managing system according to claim 17, characterised in that:
the system comprises means for receiving (HAS) a notification of a failure or detecting a failure in one or more entities or pieces of physical equipment (EQ);
said extended naming service framework (ENS) comprises an interface for receiving (IF) a request for services (SE) that are linked to said failed one or more entities or pieces of physical equipment (EQ);
means for checking (CM) said information of said services (SE); and
means for sending (NM) information about those services (SE) matching to the request.

29. The dynamic managing system according to claim 17, characterised in that the computer system comprises at least one extended naming service framework (ENS).

30. The dynamic managing system according to claim 17, characterised in that said extended naming service framework (ENS) functionality is implemented using the CORBA.

31. The dynamic managing system according to claim 17, characterised in that said extended naming service framework (ENS) is a standalone naming service.

32. The dynamic managing system according to claim 17, characterised in that said extended naming service framework (ENS) is part of a conventional naming service.

33. An extended naming service framework for enabling service availability in a computer system, wherein the extended naming service framework comprises at least:
an interface (IF) for receiving messages from client applications (SU), server applications (SP) and/or a management entity (HAS),
characterised in that:
said extended naming service framework (ENS) registers one or more services, and stores information about said one or more services (SE), said information acquired in said registering process of services (SE), and links a certain service (SE) to a certain entity or physical equipment (EQ) providing said service.

34. The extended naming service framework according to claim 33, characterised in that said extended naming service framework (ENS) registers one or more client applications (SU) and stores information about said client applications (SU), said information acquired in said registering process of said client applications (SU), and links a certain client application (SU) to a certain service (SE).

35. The extended naming service framework according to claim 34, characterised in that said information of said client applications (SU) comprise at least one of the following:
name of the client;
interface address of the client;
client status; and
physical information about the client.

36. The extended naming service framework according to claim 33, characterised in that said information of said services (SE) comprise at least one of the following:
name of the service;
service access point to which the service belongs;
interface address of the service;
service status; and
physical information about the service.

37. The extended naming service framework according to claim 33, characterised in that the extended naming service framework (ENS) comprises:
an interface (IF) for receiving from said management entity (HAS) a notification that an entity or a piece of physical equipment (EQ) is malfunctioning; and
means for updating (UM) status information of services (SE) which are provided by said malfunctioning entity or piece of equipment (EQ).

38. The extended naming service framework according to claim 37, characterised in that the extended naming service framework (ENS) comprises:
means for notifying (NM) the changed status information to client applications (SU) that are registered to use said services (SE) provided by said malfunctioning entity or piece of equipment (EQ).

39. The extended naming service framework according to claim 33, characterised in that the extended naming service framework (ENS) comprises:
an interface for receiving (IF) a service subscription from a client application (SU), wherein said service subscription comprises at least one or more of the following:
name of the service (SE) in question;
service access point to which said service (SE) belongs;
physical or other properties of said service (SE), service (SE) status;
service (SE) availability;
number of instances of said service (SE); and
reference of the callback interface for said client application (SU).

40. The extended naming service framework according to claim 39, characterised in that the extended naming service framework (ENS) comprises:
means for notifying (NM) a client application (SU) when a status of a service (SE) of which said client application (SU) is aware of, changes.

41. The extended naming service framework according to claim 33, characterised in that the extended naming service framework (ENS) comprises:
an interface for receiving (IF) a service search request from a client application (SU); and
means for providing (NM) said client application (SU) the requested service information if a service (SE) matches search criteria.

42. The extended naming service framework according to claim 41, characterised in that the search criteria comprises one or more of the following:
instance identifier of a service; or
a particular database fragment.

43. The extended naming service framework according to claim 33, characterised in that the extended naming service framework (ENS) comprises one or more distribution rules (DR) to be applied when a service (SE) registered in the extended naming service framework (ENS) comprises two or more instances of a service (SE).

44. The extended naming service framework according to claim 33, characterised in that:
the system comprises means for detecting (HAS) a failure in one or more entities or pieces of physical equipment (EQ);
said extended naming service framework (ENS) comprises an interface for receiving (IF) a request for services (SE) that are linked to said failed one or more entities or pieces of physical equipment (EQ);
means for checking (CM) said information of said services (SE); and
means for sending (NM) information about those services (SE) matching to the request.

45. The extended naming service framework according to claim 33, characterised in that the computer system comprises one or more extended naming service frameworks (ENS).

46. The extended naming service framework according to claim 33, characterised in that said extended naming service framework (ENS) functionality is implemented using the CORBA.

47. The extended naming service framework according to claim 33, characterised in that said extended naming service framework (ENS) is a standalone naming service framework.

48. The extended naming service framework according to claim 33, characterised in that said extended naming service framework (ENS) is part of a conventional naming service framework.
